(19) United States
(12) Patent Application Publication
(10) Pub. No.: US 2026/0081070 A1
(43) Pub. Date: Mar. 19, 2026

(54) CONDUCTIVE INDIUM TIN OXIDE FILM WITH PIEZOELECTRIC PROPERTIES, METHOD FOR PREPARING THE SAME, AND CAPACITORS USING THE SAME

(71) Applicant: National Cheng Kung University, Tainan City (TW)

(72) Inventors: Jr Jeng Ruan, Tainan City (TW); Huan En Lin, Tainan City (TW); Yi Hsueh Chen, Tainan City (TW)

(73) Assignee: National Cheng Kung University, Tainan City (TW)

(21) Appl. No.: 18/932,236

(22) Filed: Oct. 30, 2024

(30) Foreign Application Priority Data
Sep. 19, 2024 (TW) 113135403

(51) Int. Cl. H01G 4/008

(52) U.S. Cl. CPC H01G 4/008

(57) ABSTRACT

The present disclosure provides a conductive indium tin oxide (ITO) film with piezoelectric properties, method for preparing the same, and capacitors using the same. The piezoelectric coefficient of the conductive ITO film with piezoelectric properties is greater than 3 pm/V, and the resistance value thereof is less than 10Ω. The present disclosure confers both piezoelectric and conductive properties to ITO by doping metal elements into ITO via a low-temperature hydrothermal method.

### CROSS-REFERENCE TO RELATED APPLICATIONS

This application claims the benefit of priority of Taiwan Application Number TW113135403, filed on 19 Sep. 2024, which is herein incorporated by reference in its entirety.

### TECHNICAL FILED

The present disclosure relates to a conductive indium tin oxide film with piezoelectric properties, particularly to a conductive indium tin oxide film with piezoelectric properties prepared by a low-temperature hydrothermal method.

### BACKGROUND

Conductive indium tin oxide (ITO) is a commonly used conductive oxide film in commercial applications, particularly in display technology and solar cells. Due to its excellent conductivity, transparency, and thermal stability, it is widely used in transparent conductive electrodes across various industries, becoming the preferred material in the industry.

On the other hand, piezoelectric materials (such as piezoelectric ceramics, piezoelectric crystals, and piezoelectric composites) possess unique material properties. They generate a potential difference when deformed, inducing a current and converting mechanical energy into electrical energy. As such, these materials have also been widely used in energy harvesting, precision instruments, sensors, health monitoring, and other fields, where they hold significant application value.

However, currently, no electrode possesses piezoelectric properties, and attempts to modify ITO slightly to improve its performance often lead to significantly increase in costs, presenting economic challenges for its application.

Additionally, during the doping process of materials, doping different elements is usually performed during the growth of the material's crystalline phase, allowing other trace elements to participate in the construction of the crystalline phase during the growth process of crystalline phase. For example, conventional methods for doping elements into oxide crystalline phases include magnetron sputtering, high-temperature calcination, coprecipitation, and sol-gel methods, all of which involve adding the precursor or ions of the doping elements during the growth process of crystalline phase. Doping elements into already grown crystalline materials, however, requires destructive methods, such as atomic bombardment or etching, making the process difficult, expensive, and prone to affecting the stability of the product.

That is, in general, oxide crystalline phases need to be prepared under extreme conditions, such as high temperatures, high pressure, or high acidity/alkalinity. Doping other elements into already-formed inorganic oxide crystalline phases often requires the use of acid etching to create defects, which is extremely costly and tends to damage the crystalline phase.

### SUMMARY

There is no development on an electrode with piezoelectric properties. Furthermore, no related research has been conducted on low-cost element doping with the conductivity of an electrode maintained while imparting piezoelectric properties, and the possibility of further using it for capacitors.

Accordingly, the present disclosure provides a conductive indium tin oxide film with piezoelectric properties. Specifically, the present disclosure provides a conductive indium tin oxide film with piezoelectric properties, characterized by having a piezoelectric coefficient greater than 3 pm/V and a resistance value of less than 10Ω.

In one aspect, the piezoelectric coefficient of the conductive indium tin oxide film is further greater than 5 pm/V, preferably greater than 6 pm/V, more preferably greater than 6.5 pm/V, and even more preferably greater than 10 pm/V. This piezoelectric property is superior to that of general zinc oxide, and, meanwhile, the conductive properties of the indium tin oxide film also maintained.

The “piezoelectric coefficient” of the present disclosure refers to the average piezoelectric coefficient obtained by placing a platinum probe in contact with the surface of a test piece, applying a voltage to the probe, and conducting it to the crystalline phase of the test piece surface, causing the crystalline phase to exhibit an inverse piezoelectric effect. The corresponding deformation under the applied voltage is then collected and converted to obtain the average piezoelectric coefficient.

In one aspect, the resistance value of the conductive indium tin oxide film is further less than 8Ω, preferably less than 7.5Ω, and more preferably less than 7Ω. Accordingly, the conductive indium tin oxide film exhibits excellent piezoelectric and conductive properties simultaneously.

In one aspect, the conductive indium tin oxide film is doped with at least one element selected from the group consisting of vanadium (V), cobalt (Co), nickel (Ni), and forms of different valences thereof.

In one aspect, the element is preferably nickel or the form of valence thereof.

Thus, the present disclosure, through doping elements including V, Co, Ni, V⁵⁺, Co²⁺, and Ni²⁺ atoms or ions into the conductive indium tin oxide film, may produce the film with excellent piezoelectric properties while maintaining its conductivity.

In one aspect, the doping amount of the aforementioned element is at least 0.30 at % relative to the entire conductive indium tin oxide film, preferably 0.50 at % to 5.00 at %, more preferably 0.53 at % to 4.00 at %, more preferably 0.70 at % to 3.00 at %, more preferably 0.76 at % to 2.00 at %, more preferably 0.80 at % to 1.00 at %, and more preferably 0.90 at % to 0.99 at %.

Thus, in the present disclosure, only a small amount of element doping is required to confer piezoelectric properties to the conductive indium tin oxide film, and through the control of the doping amount, the piezoelectric and/or conductive properties of the conductive indium tin oxide film may be further improved.

In one aspect, the doped elements are present in the ITO crystalline phase, and carbon elements on the surface of the ITO are bonded (C—C, C═C) within the ITO crystalline phase, rather than existing as carbon layers on top of the ITO crystalline phase.

The present disclosure also provides a preparation method for the conductive indium tin oxide film with piezoelectric properties as described above, characterized by using a low-temperature hydrothermal method for element doping. The “low-temperature” in the low-temperature hydrothermal method is defined as a temperature below 100° C., preferably below 90° C., more preferably below 80° C., and more preferably below 60° C.

In one aspect, the preparation method includes the following steps:
(1) Dissolve a metal ion precursor in a hexamethylenetetramine aqueous solution to prepare a hydrothermal solution;
(2) Place indium tin oxide in a Teflon bottle, and add the hydrothermal solution into the Teflon bottle; and
(3) Place the Teflon bottle into a hydrothermal autoclave and put it in an oven at a temperature below 100° C. for 15 to 60 minutes to conduct the low-temperature hydrothermal method, take out the conductive indium tin oxide film, cool it, and then preferably clean the film surface with deionized water to remove surface impurities, resulting in a conductive indium tin oxide film with piezoelectric properties.

The inventors have surprisingly found that, through the steps of the preparation method described above, doping elements into already grown oxide crystalline phases may be conducted by the low-cost hydrothermal method instead of costly and difficult conventional processes, while avoiding damage to the grown crystalline phase. Furthermore, through element doping, conductive crystalline phases, which are originally non-polar, may be endowed with piezoelectric properties, resulting in an unprecedented technical breakthrough.

In one aspect, the metal ion precursor is selected from a group consisting of NH₄VO₃, Co(NO₃)₂, Ni(NO₃)₂, and/or hydrates thereof, such as Co(NO₃)₂·6H₂O or Ni(NO₃)₂·6H₂O.

In one aspect, the low-temperature hydrothermal method is conducted at a temperature below 100° C. for 15 to 60 minutes, preferably below 80° C. for 15 to 60 minutes, more preferably below 80° C. for 20 to 40 minutes, and more preferably at approximately 60° C. for approximately 30 minutes. Accordingly, the present disclosure offers a low-cost, commercially viable technique for doping various elements into already-developed conductive oxide crystalline phases, adjusting the crystalline phase polarity to impart piezoelectric properties to the conductive film.

In one aspect, during the preparation process of the low-temperature hydrothermal method, the pH value of the hydrothermal solution is maintained between 6 and 8, preferably at pH 7. As a result, element doping of the conductive indium tin oxide film is performed in a neutral environment, thereby avoiding damage to the original crystalline phase.

In one aspect, the weight percentage concentration of the metal ion precursor in the hexamethylenetetramine aqueous solution is 0.01 wt % to 0.10 wt %, preferably 0.02 wt % to 0.08 wt %, more preferably 0.03 wt % to 0.06 wt %, and more preferably 0.04 wt % to 0.05 wt %.

Accordingly, the present disclosure, through the adjustment of experimental parameters and the weight percentage concentration of the metal ion precursor, may further reduce the complexity of the process and enhance the piezoelectric and/or conductive properties of the conductive indium tin oxide film.

The conductive indium tin oxide film with piezoelectric properties of the present disclosure, through doping elements into ITO via a low-temperature hydrothermal method, unprecedentedly imparts piezoelectric properties to electrodes. It may be widely used in transparent conductive electrodes, touch capacitors, nanogenerators, pressure sensing components, polymer capacitors, and other components requiring electrodes, bringing substantial commercial effects to industries such as the semiconductor, electronics, and traditional industries.

For example, the present disclosure may be applied in the pressure-sensing nanogenerator industry, where doping indium tin oxide as an electrode may further enhance the pressure sensing response, overcoming the output limitations of nanogenerators.

For example, the present disclosure may be applied in the polymer capacitor industry. By using doped indium tin oxide as the electrode of the capacitor and placing a polymer insulating material between the two electrodes, due to the pressure sensitivity of the electrodes in the present disclosure, the material may have polarity. This, in turn, may significantly increase the amount of charge accumulated at both ends of the capacitor, effectively enhancing the capacitance value of the polymer during the development of polymer capacitors.

For example, the present disclosure may be applied in the touch capacitor industry, where, unlike prior art designs involving multilayer electrodes with capacitor materials, the doped indium tin oxide with polarity may simultaneously serve as the electrode and the capacitor design component.

Thus, the present disclosure also provides a capacitor characterized by using the conductive indium tin oxide film as the capacitor electrode.

The conductive indium tin oxide film with piezoelectric properties of the present disclosure may offer the following effects:
1. Development of an ITO film with piezoelectric properties.
2. Development of using a low-temperature hydrothermal method for doping elements into already-grown crystalline phases.
3. In summary, a low-cost, commercially viable technique for doping various elements into already-developed conductive oxide crystalline phases is developed, to adjust crystalline phase polarity, and impart polarity and piezoelectric properties to the conductive oxide crystalline phase.
4. Development of capacitors using ITO films with piezoelectric properties as electrodes, significantly increasing the number of charges accumulated at both ends of the capacitor.
5. Significant enhancement in efficiency of nanogenerator through the application of ITO films with piezoelectric properties.

### BRIEF DESCRIPTION OF THE DRAWINGS

FIG. 1A shows an SEM image showing the surface morphology of the undoped ITO.

FIG. 1B shows an AFM (Atomic Force Microscope) image showing the surface of the undoped ITO.

FIG. 1C shows an SEM image showing the surface morphology of the vanadium-doped ITO.

FIG. 1D shows an AFM image showing the surface of the vanadium-doped ITO.

FIG. 2A shows an AFM image showing the surface morphology of the cobalt-ion-doped ITO.

FIG. 2B shows an AFM image showing the surface morphology of the nickel-ion-doped ITO.

FIG. 3 shows the piezoelectric coefficient distribution chart for various cobalt-ion doping concentration within the ITO crystalline phase.

FIG. 4 shows the difference in piezoelectric coefficients of ITO after doped with cobalt.

FIG. 5 shows the piezoelectric coefficient distribution chart for various ITO products with different doped elements in their crystalline phases.

FIG. 6 shows differences in piezoelectric coefficients of various ITO products.

### DETAILED DESCRIPTION

The present disclosure will be described with figures and embodiments. It should be understood that the following embodiments are only for describing and explaining the content of the present disclosure and are not intended to limit the scope of the present disclosure and claims.

The present disclosure provides a method for doping elements into ITO using a low-temperature hydrothermal process to prepare an ITO film with piezoelectric properties, wherein the doped elements are present within the ITO crystalline phase, and carbon elements on the surface of ITO are bonded (C—C, C═C) within the ITO crystalline phase.

In one embodiment of the present disclosure, the steps for preparing the ITO film with piezoelectric properties include the following:
(1) Ultrasonically cleaning the ITO glass (ITO transparent conductive electrode, provided by Uni-onward);
(2) Dissolving NH₄VO₃, Co(NO₃)₂, Ni(NO₃)₂, and/or hydrates of NH₄VO₃, Co(NO₃)₂, Ni(NO₃)₂ as metal ion precursors at a concentration of 0.02 wt %˜0.06 wt % in a hexamethylenetetramine (HMTA) aqueous solution to prepare a hydrothermal solution;
(3) Placing the ITO glass into a Teflon bottle and adding the hydrothermal solution into the Teflon bottle; and
(4) After placing the Teflon bottle into a hydrothermal autoclave and put it in an oven to perform the low-temperature hydrothermal method, taking out the ITO glass and allowing it to cool; and then, preferably, rinsing the surface of the ITO with deionized water to remove surface impurities, yielding a conductive indium tin oxide film with piezoelectric properties.

During the preparation process of the low-temperature hydrothermal method, the pH value of the hydrothermal solution is maintained at approximately 7. Accordingly, the step of doping elements into ITO is carried out in a neutral environment to avoid damaging the original crystalline phase.

The ITO film prepared by this low-temperature hydrothermal method in a neutral environment has been proved to exhibit piezoelectric properties, further showing a piezoelectric coefficient (d₃₃) greater than 3 pm/V.

Next, the experimental parameters of the low-temperature hydrothermal method were adjusted to conduct the hydrothermal process at 60° C. for 30 minutes, with different metal ion precursors added for doping to observe the properties of the prepared ITO.

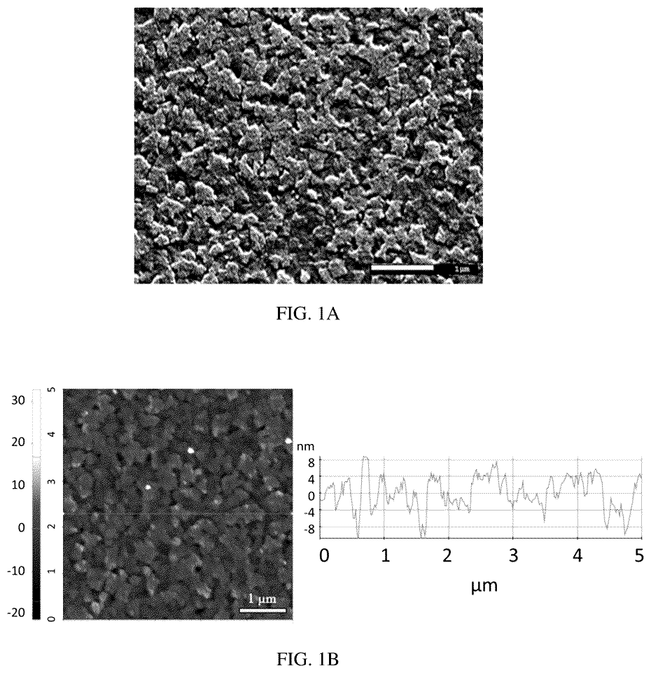

First, in the case where the metal ion precursor was 1.71 mM (0.02 wt %) NH₄VO₃, i.e., the doped element was V⁵⁺, SEM (JEOL JSM-7001) and AFM (XE7, Park System) were used to observe the effects of doping on the surface morphology of ITO. The results are shown in FIGS. 1A, 1B, 1C and 1D, where FIG. 1A shows the SEM image of the surface morphology of the undoped ITO, FIG. 1B shows the AFM image of the surface of the undoped ITO, FIG. 1C shows the SEM image of the surface morphology of the vanadium-doped ITO, and FIG. 1D shows the AFM image of the surface of the vanadium-doped ITO. It may be observed that doping vanadium has almost no effect on the surface morphology of ITO.

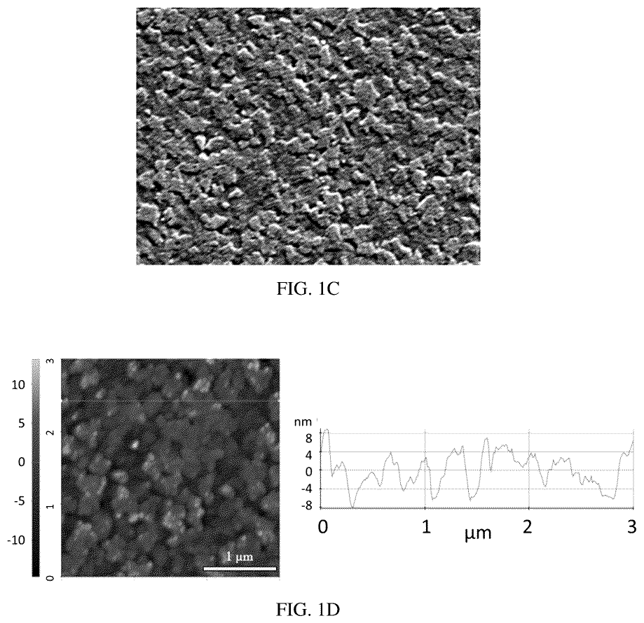

Similarly, the surface morphology of ITO doped with cobalt and nickel ions was observed, and the results are shown in FIGS. 2A to 2B, where FIG. 2A shows the AFM image of the surface morphology of cobalt-ion-doped ITO and FIG. 2B shows the AFM image of the surface morphology of nickel-ion-doped ITO. It may be observed that the surface morphologies of the cobalt-ion-doped ITO and the nickel-ion-doped ITO were not altered under the low-temperature hydrothermal method of this embodiment.

Next, piezoelectric properties were measured using Piezoresponse Force Microscopy (PFM) (instrument model: XE7 Park System). A platinum probe was placed in contact with the surface of the test piece, a voltage was applied to the probe, and conducted to the crystalline phase of the test piece surface, causing the crystalline phase to exhibit an inverse piezoelectric effect. The corresponding deformation under the applied voltage was collected and converted into a piezoelectric coefficient.

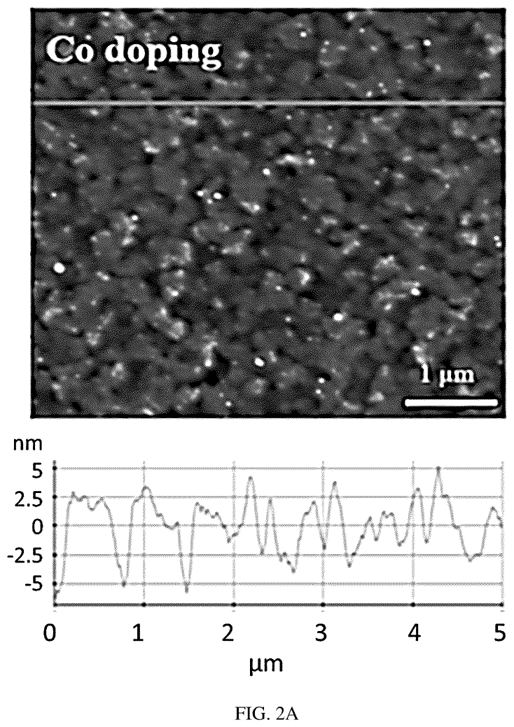

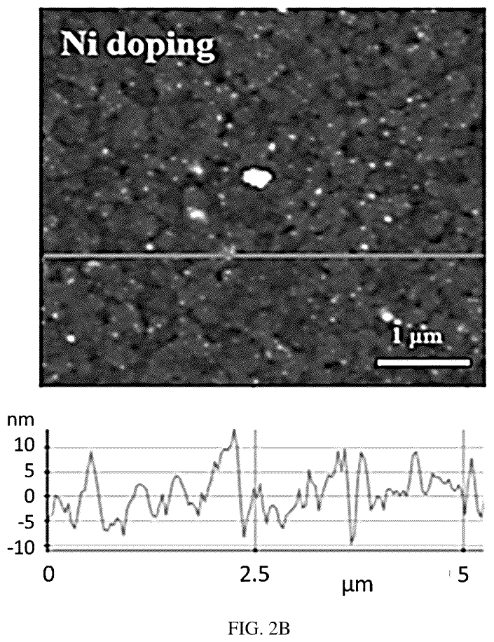

First, in the case of cobalt-ion doping, the concentration of the metal ion precursor was adjusted (2.06 mM (0.06 wt %), 1.37 mM (0.04 wt %), 0.69 mM (0.02 wt %)), and the proportion of cobalt in the final product (i.e., the conductive indium tin oxide film with piezoelectric properties) was measured (0.99 at %, 0.76 at %, 0.53 at %), along with the corresponding piezoelectric coefficient results. FIG. 3 shows the piezoelectric coefficient distribution for various cobalt-ion doping concentrations in the ITO crystalline phase, and FIG. 4 shows the differences in piezoelectric coefficients of ITO after doped with cobalt. The piezoelectric coefficients and resistance values derived from the results are shown in Table 1, indicating that in comparison with undoped ITO, cobalt doping imparts piezoelectric properties to the ITO without affecting its conductivity. Additionally, in this embodiment, a general positive correlation between the concentration of the metal ion precursor and the piezoelectric coefficient was observed.

TABLE 1

| | d₃₃ | Resistance Value |
|---|---|---|
| Undoped ITO | None | 6.5~7 Ω |
| Co²⁺-doped (0.53 at %) | 6.5 pm/V | 6.5~7 Ω |
| Co²⁺-doped (0.99 at %) | 10.2 pm/V | 6.5~7 Ω |

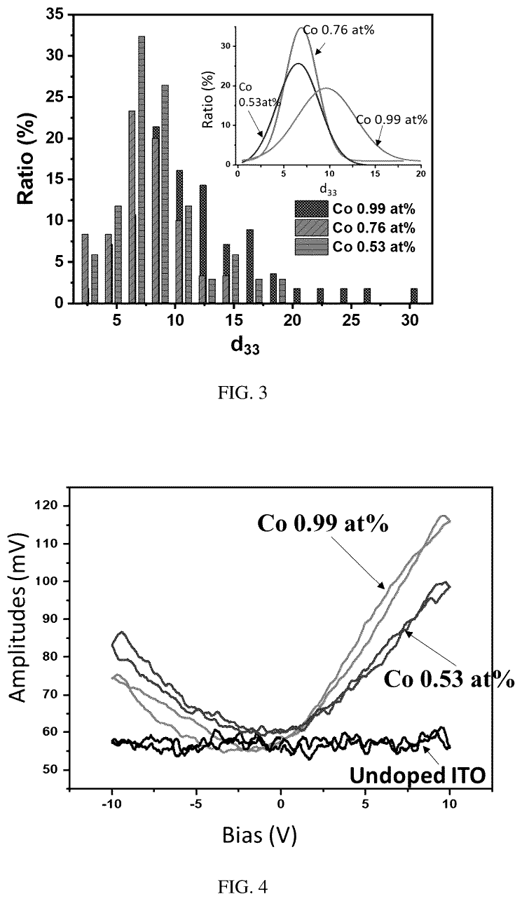

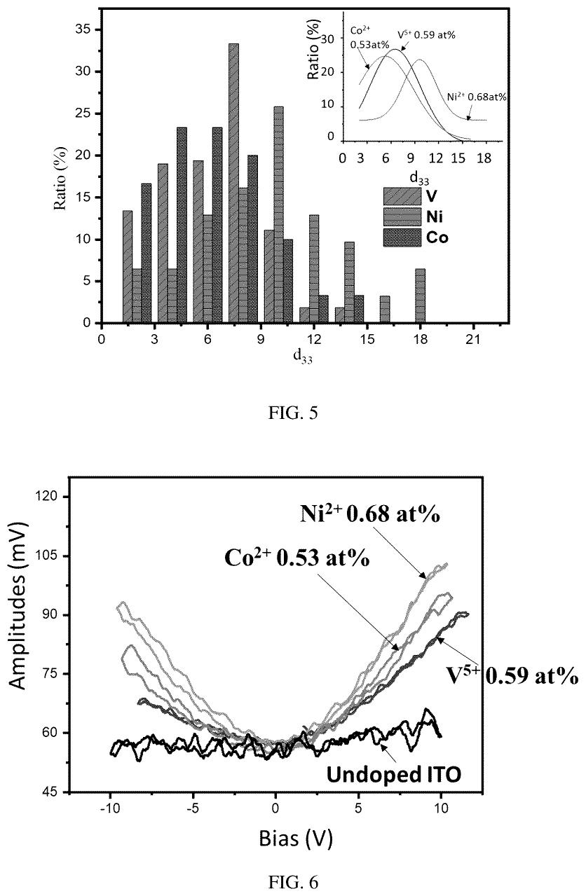

Next, different elements (Co²⁺ 0.02 wt %, Ni²⁺ 0.02 wt %, V⁵⁺ 0.06 wt %) were doped into ITO, and the proportion of each element in the final product was measured (Co²⁺ 0.53 at %, Ni²⁺ 0.68 at %, V⁵⁺ 0.59 at %), along with the corresponding piezoelectric coefficient results. FIG. 5 shows the result of the piezoelectric coefficient distribution for each final product with different doped elements in the ITO crystalline phase, and FIG. 6 shows the differences in piezoelectric coefficients of the final ITO products. The piezoelectric coefficients and resistance values derived from the results are shown in Table 2, indicating that in comparison with undoped ITO, element doping imparts piezoelectric properties to ITO without affecting its conductivity. Additionally, in this embodiment, it can be found that nickel doping may confer higher piezoelectric properties to ITO.

TABLE 2

| | |
|---|---|
| d₃₃ | Resistance Value |

| | | |
|---|---|---|
| Pure ITO | None | 6.5~7 Ω |

| | | | |
|---|---|---|---|
| Co²⁺-doped (0.53 at %) | 6.5 | pm/V | 6.5~7 Ω |
| Ni²⁺-doped (0.68 at %) | 10.5 | pm/V | 6.5~7 Ω |
| V⁵⁺-doped (0.59 at %) | 6 | pm/V | 6.5~7 Ω |

In summary, the present disclosure provides a method for doping metal elements into ITO using a low-temperature hydrothermal process, enabling ITO to exhibit both piezoelectric and conductive properties. It should be understood by those skilled in the art that, based on the teachings of the present specification, modifications, adjustments, and variations may be made to the preparation method of the present disclosure without departing from the spirit and scope of the present disclosure. Such modifications, adjustments, and variations, including using different metal precursors, combining different metal precursors, or adjusting the concentration of metal ion precursors, also fall within the scope of the appended claims.

The terms used in this specification are for the purpose of describing particular embodiments only and is not intended to limit the present disclosure. As used in the present disclosure, the singular forms “a”, “an” and “the” do not imply a limitation on quantity and should be interpreted as including the plural form unless the context explicitly indicates otherwise.

All ranges disclosed in the present disclosure encompass the endpoints and all combinations of endpoints and intermediate values. The terms “greater than” and “less than” include the respective values themselves. The term “combinations thereof” includes one or more of the listed elements and is inclusive. It should also be understood that, as used in this specification, the term “comprising” specifies the presence of stated features, ingredients, steps, elements, and/or components, but does not preclude the presence or addition of one or more other features, ingredients, steps, elements, components, and/or combinations thereof.

The term “aspect” or “embodiment” refers to the relevant description of the aspect or embodiment that may be included in at least one aspect or embodiment of the present disclosure and may or may not be present in other aspects or embodiments.

While preferred embodiments have been described, it should be understood that those skilled in the art, now and in the future, can make various improvements and modifications that fall within the scope of the appended claims. These claims should be interpreted to maintain proper protection for the original disclosure.

What is claimed is:

1. A conductive indium tin oxide film with piezoelectric properties, characterized by having a piezoelectric coefficient greater than 3 pm/V and a resistance value of less than 10Ω.

2. The conductive indium tin oxide film with piezoelectric properties according to claim 1,
wherein the piezoelectric coefficient of the conductive indium tin oxide film is greater than 5 pm/V.

3. The conductive indium tin oxide film with piezoelectric properties according to claim 1, wherein the resistance value of the conductive indium tin oxide film is less than 8Ω.

4. The conductive indium tin oxide film with piezoelectric properties according to claim 1, wherein the conductive indium tin oxide film is doped with at least one element selected from a group consisting of vanadium (V), cobalt (Co), nickel (Ni), and forms of different valences thereof.

5. A method for preparing the conductive indium tin oxide film with piezoelectric properties according to claim 1, characterized by performing element doping using a low-temperature hydrothermal method at a temperature below 100° C.

6. The method for preparing the conductive indium tin oxide film with piezoelectric properties according to claim 5, comprising steps of:
(1) Dissolving a metal ion precursor in an aqueous solution of hexamethylenetetramine to prepare a hydrothermal solution;
(2) Placing an indium tin oxide film and the hydrothermal solution into a Teflon bottle; and
(3) Placing the Teflon bottle into a hydrothermal autoclave and heating it in an oven at a temperature of less than 100° C. for 15 to 60 minutes, then taking it out and cooling it.

7. The method for preparing the conductive indium tin oxide film with piezoelectric properties according to claim 6, wherein the metal ion precursor is at least one selected from a group consisting of NH₄VO₃, Co(NO₃)₂, Ni(NO₃)₂, and hydrates thereof.

8. The method for preparing the conductive indium tin oxide film with piezoelectric properties according to claim 6, wherein the low-temperature hydrothermal method is conducted at a temperature of 60° C. for 30 minutes.

9. The method for preparing the conductive indium tin oxide film with piezoelectric properties according to claim 6, wherein a weight percentage concentration of the metal ion precursor in the aqueous solution of hexamethylenetetramine is from 0.02 wt % to 0.06 wt %.

10. A capacitor, characterized by using the conductive indium tin oxide film with piezoelectric properties according to claim 1 as an electrode.
